(19) United States
(12) Patent Application Publication
(10) Pub. No.: US 2026/0339423 A1
(43) Pub. Date: Oct. 29, 2026

(54) INFORMATION PROCESSING DEVICE, INFORMATION PROCESSING METHOD, AND PROGRAM

(71) Applicant: SONY GROUP CORPORATION, Tokyo (JP)

(72) Inventors: Makoto Yamada, Kanagawa (JP); Takashi Kinoshita, Tokyo (JP)

(73) Assignee: Sony Group Corporation, Tokyo (JP)

(21) Appl. No.: 19/118,199

(22) PCT Filed: Sep. 25, 2023
(86) PCT No.: PCT/JP2023/034646

§ 371 Date: Apr. 3, 2025

(30) Foreign Application Priority Data
Oct. 13, 2022 (JP) 2022-164513

(51) Int. Cl. G06F 3/01; G06F 16/683; G06F 16/687

(52) U.S. Cl. CPC G06F 3/011; G06F 16/683; G06F 16/687; G06F 2203/011

(57) ABSTRACT

The present disclosure relates to an information processing device, an information processing method, and a program that are capable of providing a better user experience with less effort.

An information processing device is provided in which behavioral patterns indicating behaviors of users are set in advance, including a control unit that sets, for a specific location identified by a relative positional relationship between a specific user and a target in real space, the behavioral pattern according to the specific user, and sets a specific content associated with the specific location from among a plurality of contents according to the set behavioral pattern. The present disclosure can be applied, for example, to devices used in services that provide spatial content.

### TECHNICAL FIELD

The present disclosure relates to an information processing device, an information processing method, and a program, and more particularly to an information processing device, an information processing method, and a program that are capable of providing a better user experience with less effort.

### BACKGROUND ART

Whether indoors or outdoors, a user being able to enjoy music that matches the user's diverse behaviors in such various locations is an important experience in daily life. Technologies for recommending music according to user's behaviors include those disclosed in, for example, PTL 1 to PTL 3.

PTL 1 discloses a technology for recommending music content based on user behavioral information. PTL 2 discloses a technology for establishing associations and generating recommendations from user behavioral data extracted by a service provider. PTL 3 discloses a technology for predicting a song desired by a user from behavioral information that indicates the user's music appreciation behavior, and automatically selecting and replaying the song.

### CITATION LIST

### Patent Literature

[PTL 1]
JP 2016-048495A
[PTL 2]
Japanese Translation of PCT Application No. 2011-511968
[PTL 3]
JP H11-288420A

### SUMMARY

### Technical Problem

The technologies disclosed in PTL 1 to PTL 3 are capable of recommending music based on a user's behavior, but are unable to place music content in a specific location to provide a sound experience to a specific user.

When service providers offering this type of experience deploy their services, they need to do on-site research works and content placement works at specific locations in order to place contents are linked with those locations, which are likely to take time and effort. Therefore, there is a demand for providing a better user experience with less effort.

The present disclosure has been made in view of such circumstances, and aims to provide a better user experience with less effort.

### Solution to Problem

An information processing device according to one aspect of the present disclosure is an information processing device in which behavioral patterns indicating behaviors of users are set in advance, including a control unit that sets, for a specific location identified by a relative positional relationship between a specific user and a target in real space, the behavioral pattern according to the specific user, and sets a specific content associated with the specific location from among a plurality of contents according to the set behavioral pattern.

An information processing method and a program according to one aspect of the present disclosure are an information processing method and a program, each corresponding to the above-described information processing device according to one aspect of the present disclosure.

In the information processing device, the information processing method, and the program according to one aspect of the present disclosure, behavioral patterns indicating behaviors of users are set in advance; for a specific location identified by a relative positional relationship between a specific user and a target in real space, the behavioral pattern according to the specific user is set; and a specific content associated with the specific location from among a plurality of contents is set according to the set behavioral pattern.

The information processing device according to one aspect of the present disclosure may be an independent device or may be an internal block in which one device is configured.

### BRIEF DESCRIPTION OF DRAWINGS

FIG. 1 is a diagram illustrating a configuration example of an embodiment of a system to which the present disclosure is applied.

FIG. 2 is a block diagram illustrating a hardware configuration example of a server in FIG. 1.

FIG. 3 is a block diagram illustrating a functional configuration example of a control unit in the server of FIG. 2.

FIG. 4 is a block diagram illustrating a hardware configuration example of a device in FIG. 1.

FIG. 5 is a block diagram illustrating a functional configuration example of a control unit in the device of FIG. 4.

FIG. 6 is a diagram schematically illustrating symbolization of behavioral patterns.

FIG. 7 is a flowchart illustrating a flow of processing on a service provider side.

FIG. 8 is a flowchart illustrating the flow of processing on the service provider side.

FIG. 9 is a flowchart illustrating a flow of replay preparation processing on the user side.

FIG. 10 is a flowchart illustrating the flow of replay preparation processing on the user side.

FIG. 11 is a diagram illustrating a first example of a UI for setting a location.

FIG. 12 is a diagram illustrating a second example of a UI for setting a location.

FIG. 13 is a diagram illustrating a third example of a UI for setting a location.

FIG. 14 is a diagram illustrating a first example of a UI for assigning a meaning to a location.

FIG. 15 is a diagram illustrating a second example of a UI for assigning a meaning to a location.

FIG. 16 is a diagram illustrating a third example of a UI for assigning a meaning to a location.

FIG. 17 is a diagram illustrating a first example of a UI for selecting content.

FIG. 18 is a diagram illustrating a second example of a UI for selecting content.

FIG. 19 is a diagram illustrating a third example of a UI for selecting content.

FIG. 20 is a diagram illustrating a first example of a UI for placing content.

FIG. 21 is a diagram illustrating a second example of a UI for placing content.

FIG. 22 is a diagram illustrating a third example of a UI for placing content.

FIG. 23 is a flowchart illustrating a flow of replay processing on the user side.

FIG. 24 is a diagram illustrating another example of the functional configuration of the control unit in the device of FIG. 4.

FIG. 25 is a flowchart illustrating a flow of adjustment processing on the user side.

FIG. 26 is a diagram illustrating a first example of a UI for adjusting settings.

FIG. 27 is a diagram illustrating a second example of a UI for adjusting settings.

FIG. 28 is a diagram illustrating a third example of a UI for adjusting settings.

FIG. 29 is a diagram illustrating still another example of the functional configuration of the control unit in the device of FIG. 4.

### DESCRIPTION OF EMBODIMENTS

### System Configuration

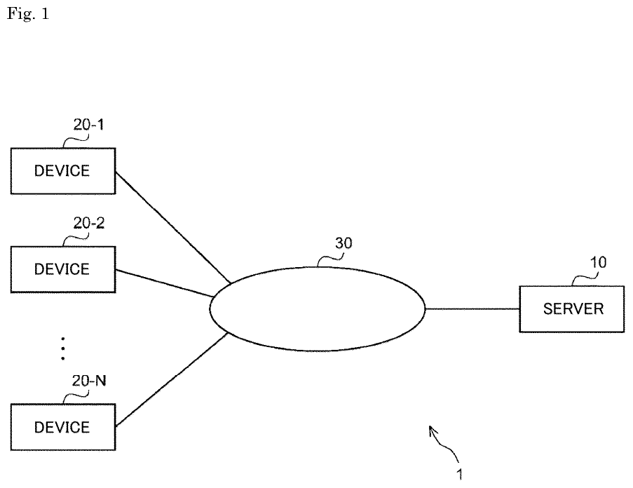

FIG. 1 is a diagram illustrating a configuration example of an embodiment of a system to which the present disclosure is applied. The system refers to a logical collection of a plurality of devices.

In FIG. 1, the system 1 is a system that provides spatial content. As the spatial content, spatial sound will be described below that provides a space of the world view (theme) of a work by sounds such as stereophonic sound. The spatial sound includes one or more spatial element contents (music contents, etc.) according to the world view of the work. The spatial content and the spatial element content are sometimes collectively referred to as content.

The system 1 includes a server 10 and devices 20-1 through 20-N (N: an integer equal to or greater than 1). The server 10 and each of the devices 20-1 to 20-N are connected to one another via a network 30 including the Internet or the like.

The server 10 is configured as a server to provide a service for spatial sound (hereinafter, simply referred to as a service). The server 10 provides the service to the devices 20-1 to 20-N via the network 30. In practice, a plurality of servers are provided for each function (service) to be provided, but for the sake of simplicity, only one server 10 is illustrated in FIG. 1. The server 10 is managed by a business entity that is a service provider side.

For example, the server 10 is configured as a server such as an application providing server, a data providing server, an application cooperation server, a content providing server, or the like. The application providing server distributes an application to use a service (hereinafter, sometimes simply referred to as an application). The application is prepared by the service provider. The data providing server provides various types of data to be used in the application. The application cooperation server performs processing in cooperation with the application. The content providing server provides spatial element content included in the spatial sound.

The device 20-1 is configured as an information device such as a smartphone, a portable music player, a tablet terminal, a wearable device, a game machine, a mobile phone, a personal computer (PC), and the like. The device 20-1 can use services provided by the server 10 via the network 30. The device 20-1 prepares for replaying spatial sound by downloading an application and exchanging data in cooperation with the server 10. When replay conditions are satisfied after completing the preparation for replay, the device 20-1 replays (spatial element content included in) the spatial sound.

Like the device 20-1, the devices 20-2 to 20-N are each configured as an information device such as a smartphone, prepare for replaying spatial sound, and when replay conditions are satisfied, replay (spatial element content included in) the spatial sound. The devices 20-1 to 20-N are used by different users. In the following description, the devices 20-1 to 20-N will be referred to as the device(s) 20 unless there is a need to particularly distinguish between them.

### Server Configuration

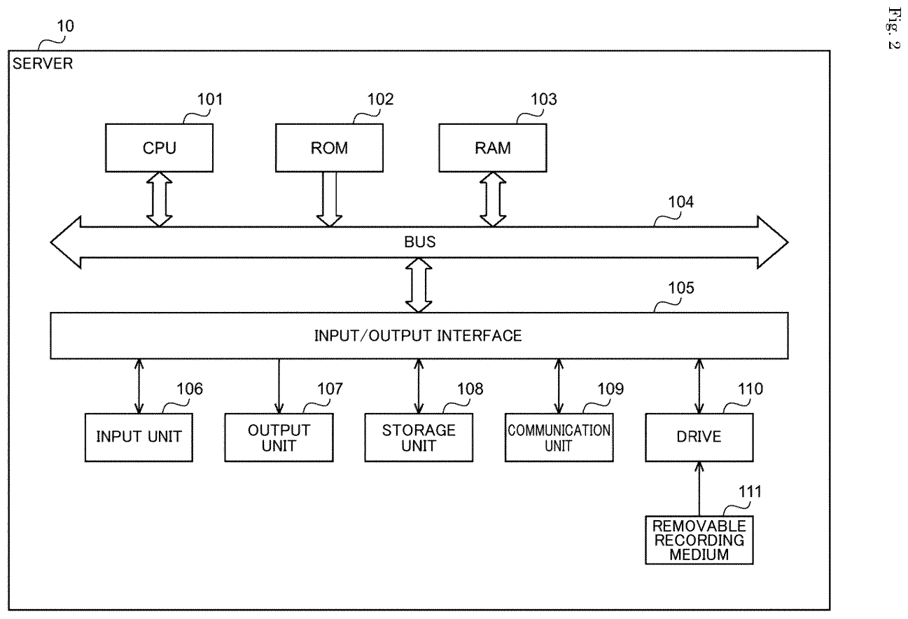

FIG. 2 is a block diagram illustrating a hardware configuration example of the server 10 in FIG. 1. The server 10 is an example of an information processing device to which the present disclosure is applied.

As illustrated in FIG. 2, in the server 10, a central processing unit (CPU) 101, a read-only memory (ROM) 102, and a random access memory (RAM) 103 are connected to one another via a bus 104. The CPU 101 controls the operation of each unit of the server 10 by executing a program recorded in the ROM 102 or a storage unit 108. Various types of data are stored in the RAM 103 as appropriate. An input/output interface 105 is also connected to the bus 104. An input unit 106, an output unit 107, the storage unit 108, a communication unit 109, and a drive 110 are connected to the input/output interface 105.

The input unit 106 is configured as an operating system such as a microphone, a keyboard, or a mouse. The output unit 107 includes a speaker, a display, and the like. The storage unit 108 is configured as an auxiliary storage device such as a hard disk drive (HDD) or a semiconductor memory. The communication unit 109 is configured as a communication circuit such as a network interface card (NIC) that supports wireless communication including a wireless local area network (LAN) or wired communication including Ethernet (registered trademark). The drive 110 drives a removable recording medium 111 such as a semiconductor memory, an optical disc, a magnetic disk, or a magneto-optical disk.

The server 10 includes servers that provide various functions, such as an application providing server, a data providing server, an application cooperation server, and a content providing server. The functions to be provided by the server 10 configured as each server are implemented by the CPU 101 executing programs corresponding to the various functions. Necessary data is used for executing the programs. The programs and data are recorded in the ROM 102 and the storage unit 108.

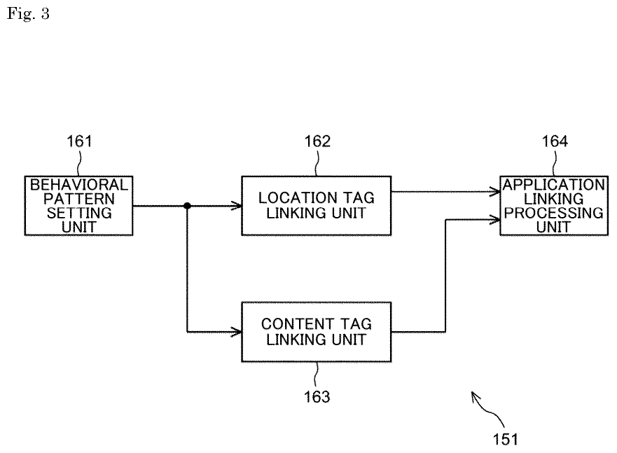

FIG. 3 is a block diagram illustrating a functional configuration example of a control unit in the server 10 of FIG. 2. The functions of the control unit in the server 10 are implemented by the CPU 101 executing programs such as applications and setting tools. Hereinafter, an application to be executed by the server 10 is also referred to as a server-side application in order to be distinguished from an application to be executed by the device 20 (device-side application).

In FIG. 3, the control unit 151 in the server 10 includes a behavioral pattern setting unit 161, a location tag linking unit 162, a content tag linking unit 163, and an application cooperation processing unit 164.

The behavioral pattern setting unit 161 sets a behavioral pattern based on the characteristics of a location and the characteristics of content. Data related to the behavioral pattern is recorded in the storage unit 108. The behavioral pattern to be set may be set through an operation of an operator or the like on the service provider side, or may be set (automatically set) without any operation of an operator or the like by performing processing of analyzing data including the characteristics of the location and the characteristics of the content.

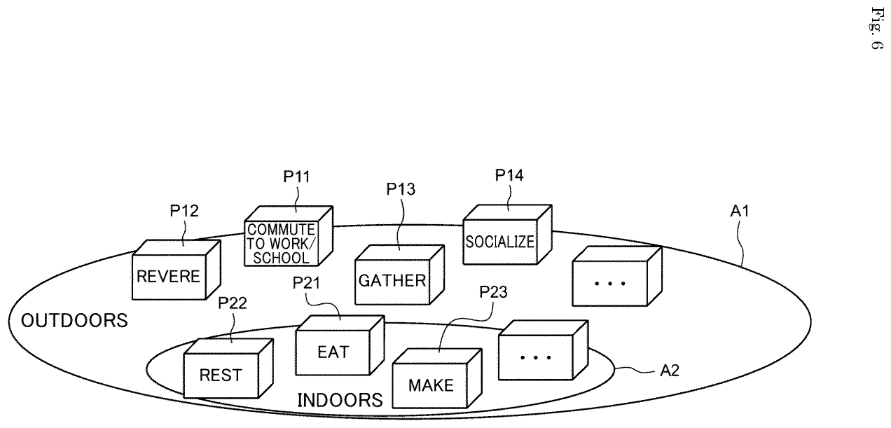

The behavioral pattern is a pattern that indicates a user's behavior that is repeated in daily life, and is prepared in advance by the service provider. A user who uses the device 20 places a desired behavioral pattern in a desired location, so that the user can be provided with a spatial sound that matches the behavioral pattern when knowing the location where the behavioral pattern is placed. Details of the behavioral pattern will be described later with reference to FIG. 6 and others.

The location tag linking unit 162 assigns a tag indicating the characteristics of a location (hereinafter also referred to as a location tag) to the set behavioral pattern. The location tag is used to link the adaptable behavioral pattern with the location. The application cooperation processing unit 164 executes processing in cooperation with an application executed on the device 20 side. The application cooperation processing unit 164 presents a behavioral pattern according to the characteristics of an outdoor or indoor location (hereinafter referred to as a set location) set by the user to the application executed on the device 20 side.

The content tag linking unit 163 assigns to a spatial element content included in the spatial sound a tag indicating the characteristics of the spatial element content (hereinafter, also referred to as a content tag). The content tag linking unit 163 also assigns a content tag to the set behavioral pattern. The content tag is used to link the adaptable behavioral pattern with the spatial element content. The application cooperation processing unit 164 cooperates with an application executed on the device 20 side to place a spatial element content associated with (linked with) the set location from among a plurality of spatial element contents according to the behavioral pattern and the spatial sound.

### Device Configuration

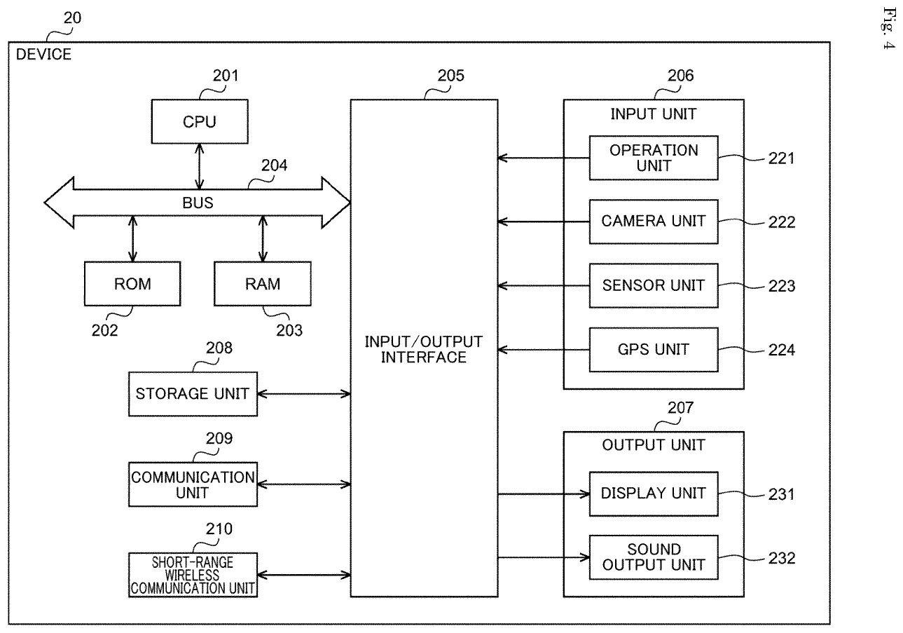

FIG. 4 is a block diagram illustrating a hardware configuration example of the device 20 in FIG. 1. The device 20 is an example of an information processing device to which the present disclosure is applied.

As illustrated in FIG. 4, in the device 20, a CPU 201, a ROM 202, and a RAM 203 are connected to one another by a bus 204. The CPU 201 controls the operation of each unit of the device 20 by executing a program recorded in the ROM 202 or a storage unit 208. Various types of data are stored in the RAM 203 as appropriate. An input/output interface 205 is also connected to the bus 204. An input unit 206, an output unit 207, the storage unit 208, a communication unit 209, and a short range wireless communication unit 210 are connected to the input/output interface 205.

The input unit 206 supplies an input signal to the units including the CPU 201 via the input/output interface 205. For example, the input unit 206 includes an operation unit 221, a camera unit 222, a sensor unit 223, and a GPS unit 224.

The operation unit 221 is operated by the user, and supplies operation data corresponding to the user operation to the CPU 201. The operation unit 221 includes physical buttons, a touch panel, and the like. The camera unit 222 performs photoelectric conversion on the light incident thereon from a subject and performs signal processing on the resulting electric signal to generate and output an image signal. The camera unit 222 includes an image sensor, a signal processing circuit, and the like.

The sensor unit 223 senses spatial information, time information, and the like, and outputs the resulting sensing signal. The sensor unit 223 includes an acceleration sensor, a gyro sensor, and the like. The acceleration sensor measures acceleration in three directions of X, Y, and Z axes. The gyro sensor measures angular velocity in three axes of X, Y, and Z axes. An inertial measurement unit (IMU) may be provided to measure three-dimensional acceleration and angular velocity using a three-directional accelerometer and a three-axis gyroscope. The sensor unit 223 includes sensors having functions of identifying feature points using a recognition technology and acquiring distance information using a distance measurement technology. The sensor unit 223 may include various sensors such as: a biosensor that measures information such as the heart rate, body temperature, or posture of a living organism; a proximity sensor that measures nearby objects; and a magnetic sensor that measures the magnitude and direction of a magnetic field.

The GPS unit 224 receives signals from Global Positioning System (GPS) satellites to measure the current position, and outputs a signal indicating the resulting current position. The GPS is an example of a positioning system. Other positioning systems may be used instead.

The output unit 207 outputs various types of information under the control of the CPU 201 via the input/output interface 205. For example, the output unit 207 includes a display unit 231 and a sound output unit 232.

The display unit 231 displays images and videos according to image signals under the control of the CPU 201. The display unit 231 includes a panel such as a liquid crystal panel, an organic light emitting diode (OLED) panel, or the like, and a signal processing circuit. The sound output unit 232 outputs a sound corresponding to a sound signal under the control of the CPU 201. The sound output unit 232 includes a speaker, headphones connected to an output terminal, and the like.

The storage unit 208 stores various types of data and programs under the control of the CPU 201. The CPU 201 reads various types of data from the storage unit 208 to process them, and executes a program. The storage unit 208 is configured as an auxiliary storage device such as a semiconductor memory. The storage unit 208 may be configured as an internal storage or may be an external storage such as a memory card.

The communication unit 209 communicates with other devices via the network 30 under the control of the CPU 201. The communication unit 209 is configured as a communication circuit such as a communication module compatible with cellular communication (e.g., LTE-Advanced, 5G, etc.), wireless communication such as wireless LAN, or wired communication. The short-range wireless communication unit 210 is configured as a communication circuit compatible with wireless communication according to a short range wireless communication standard such as Bluetooth (registered trademark) or near field communication (NFC).

The configuration of the device 20 illustrated in FIG. 4 is an example, and one or some blocks may be removed therefrom or a new block may be added thereto. For example, a microphone may be provided as the input unit 206, or an image processing circuit such as a graphics processing unit (GPU) may be provided.

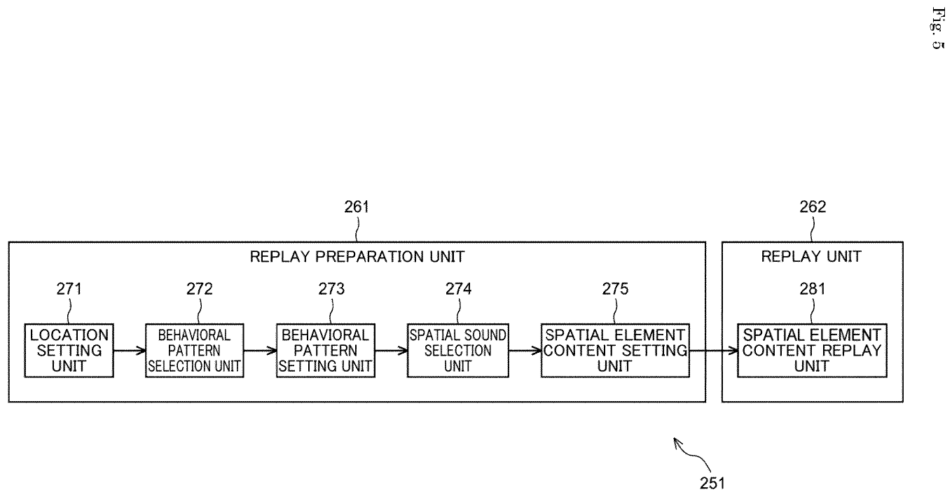

FIG. 5 is a block diagram illustrating a functional configuration example of a control unit in the device 20 of FIG. 4. The functions of the control unit in the device 20 are implemented by the CPU 201 executing a program of an application (device-side application) downloaded from the server 10.

In FIG. 5, the control unit 251 in the device 20 includes a replay preparation unit 261 and a replay unit 262. The replay preparation unit 261 performs replay preparation processing to prepare for replaying (spatial element content included in) a spatial sound in which the spatial sound is set with a meaning assigned to a location in response to a user operation. The replay unit 262 performs replay processing to replay (the spatial element content included in) the spatial sound based on the settings set in the replay preparation processing.

The replay preparation unit 261 includes a location setting unit 271, a behavioral pattern selection unit 272, a behavioral pattern setting unit 273, a spatial sound selection unit 274, and a spatial element content setting unit 275.

The location setting unit 271 sets locations as outdoors or indoors in response to user operations. The behavioral pattern selection unit 272 presents the behavioral patterns acquired from the server 10 and receives a selection from the user, thereby selecting a behavioral pattern for a set location. The behavioral pattern setting unit 273 sets the selected behavioral pattern for the set location.

The spatial sound selection unit 274 presents the spatial sounds acquired from the server 10 and receives a selection from the user, thereby selecting a spatial sound for the set location. The spatial element content setting unit 275 places the spatial element content associated with the set location (linked with the set location) according to the selected behavioral pattern and spatial sound, and sets that spatial element content as the spatial element content to be replayed when replay conditions are satisfied.

The replay unit 262 includes a spatial element content replay unit 281. If it is determined that the replay conditions are satisfied, the spatial element content replay unit 281 replays the set spatial element content. The replay conditions include, for example, that the user who owns the device 20 is present within a range corresponding to the set location, and that setting conditions set in advance are satisfied.

### Linking Location and Content Based on Behavioral Pattern

In the system 1 configured as described above, behavior (including an action and a movement) in each location is linked with the content the user wishes to select through a behavioral pattern, making it possible to more easily and efficiently present content related to a mental image the user has of each location. In other words, by linking the location and the content through the behavioral pattern, it is possible to facilitate the selection and placement of the content related to the behavior in each location. Since a behavioral pattern is selected by each user and differs depending on each user, customization for each individual user can be efficiently performed.

With the method proposed in the present disclosure, when using behavioral patterns, attention is paid to the fact that many of the basic daily behaviors of a typical user are uniform and repetitive. The location of a user's activities in the living area, which includes not only outdoors but also indoors, does not change significantly. Furthermore, the routes of daily life connecting different locations rarely change significantly, and the behaviors in the location and from one location to the other are similar. Then, the similar behavior is defined as a behavioral pattern. The behavioral patterns are prepared in advance by the service provider. With the method proposed in the present disclosure, a user places pre-prepared behavioral patterns in preferred locations, so that the user is provided with a user experience based on content that matches a behavioral pattern when knowing the location information.

A behavioral pattern is a user's behavior that is repeated in daily life, and the behavioral patterns include, for example, habitual behaviors such as “commute to work”, “commute to school”, “get dressed”, “eat”, and “sleep”. In other words, the behavioral pattern is a symbolic representation of the user's habitual, particularly daily, behavior, and clearly indicates the user's behavior, mental image, and the like.

FIG. 6 is a diagram schematically illustrating symbolization of behavioral patterns. In FIG. 6, when the outdoor area is represented by a region A1 and the indoor area is represented by a region A2 in the living area, behavioral patterns in outdoors and indoors are illustrated, respectively. For outdoors, for example, “commute to work/school”, “revere”, and “gather”, “socialize” are defined as behavioral patterns P11 to P14. For indoors, for example, “eat”, “rest”, and “make” are defined as behavioral patterns P21 to P23.

The service provider prepares behavioral patterns in advance, assuming user's various daily behaviors and mental images so that the user can easily select one of them. Furthermore, by using input methods such as natural language by the user, expressions related to the user's own behavior, goals, actions, image mental, and the like can be analyzed, and various technologies such as machine learning can be utilized to increase examples and expressions of verbalization of behavioral patterns.

A behavioral pattern is assigned a tag such as a location tag or a content tag. On the basis of the behavioral pattern with a tag assigned, the related location and related content are linked with each other. The tag assigned to the behavioral pattern is an example of meta-information related to the behavioral pattern. Linking information between the location and content via (the tag of) the behavioral pattern can be updated at any time based on the user's service usage record. This linking information is not only intended to improve the accuracy of the selection and timing of content to be replayed according to the user's behavior, but can also be used to accumulate the meaning of each location, even accumulate and analyze the meaning of content as the user's actual usage record information, and thus can be used for various application (use and utilization).

For example, it is assumed that the user sets a behavioral pattern of “commute to work/school” for an upslope between the user's home and the nearest train station. In this case, the presence of the upslope is also recognized from map information, and it is easy to imagine that traveling up that slope will require more energy than usual. However, if the slope is a place that the user visits on the way to work or school, then in addition to the physical energy required for the normal behavior of going up the slope, the user also has a desire to secure mental energy, such as an elevation of awareness and vitality, for work or studies. The latter requirement is clearly different from a behavior expected from the static information that can be read from the map, and is based on dynamic information such as the purpose of the user's behavior and the user's mental image, which can be considered subjective to the user. With the method proposed in the present disclosure, such dynamic information is acquired in association with a behavioral pattern, making it possible to replay content that corresponds to the purpose of the user's behavior and the user's mental image, such as the user enthusiastically heading to work or study in an outdoor location such as an upslope.

As examples of user experiences indoors, the following cases are envisioned. It is assumed that the user moves to the vicinity of the bed in the bedroom with the device 20 at around 11 p.m. In this case, a behavioral pattern of “sleep” or “rest” is preset for a location in the vicinity of the bed. Thus, when the user's behavior is to take place, for example, the evening before a weekend vacation, content that provides a particularly soothing user experience can be replayed.

In this way, with the method proposed in the present disclosure, a specific location and specific content are associated with (linked with) each other through (tag of) a behavioral pattern, thereby allowing content to be selected and replayed taking into consideration the user's behavior, mental image, and the like, so that it is possible to provide content that the user expects to be replayed appropriately in each location. This makes it possible to provide a better user experience.

### Processing on Service Provider Side

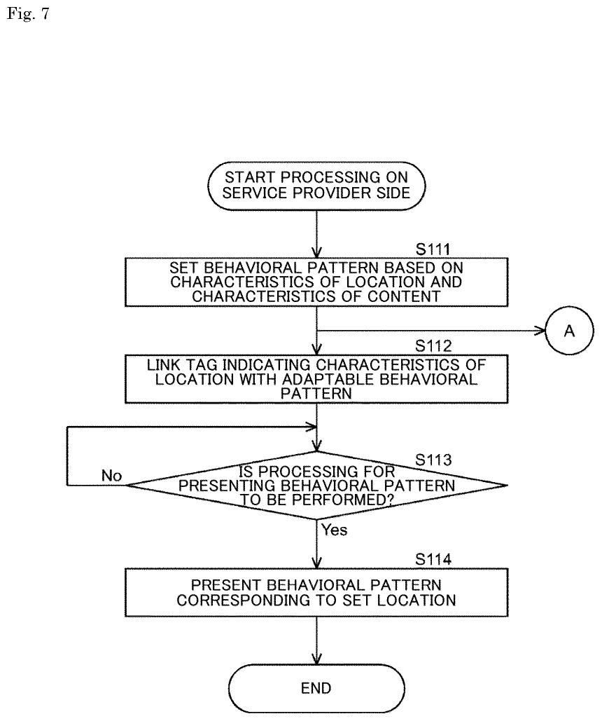

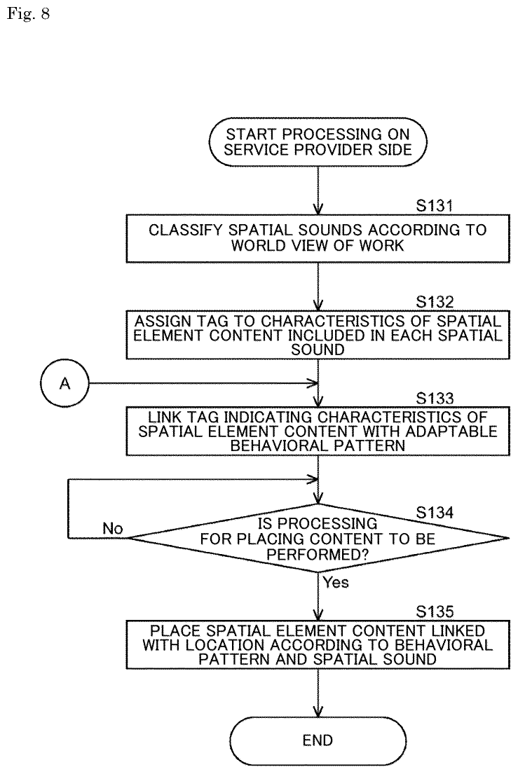

Next, processing executed by each device in the system 1 will be described in detail. First, a flow of processing on the service provider side executed by the control unit 151 of the server 10 will be described with reference to flowcharts of FIGS. 7 and 8.

FIG. 7 illustrates a flow of processing for linking a behavioral pattern with a location and presenting the behavioral pattern. In step S111, the behavioral pattern setting unit 161 sets a behavioral pattern based on the characteristics of a location and the characteristics of content. For example, behavioral patterns are set as “commute to work/school”, “eat”, “relax”, and “sleep”.

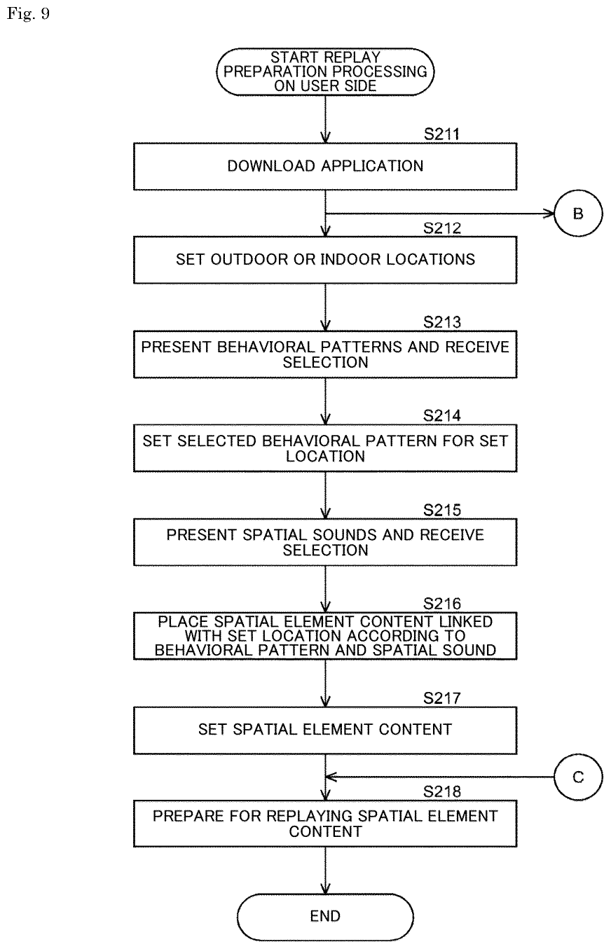

In step S112, the location tag linking unit 162 assigns a tag (location tag) indicating the characteristics of a location to a behavioral pattern, thereby linking the adaptable behavioral pattern with the location tag. This linking processing is executed before replay preparation processing on the user side (FIG. 9) is performed, and the behavioral pattern with the location tag assigned is prepared in advance as linking information.

In step S113, it is determined whether or not to perform processing for presenting a behavioral pattern. In step S113, the processing waits until a determination that the processing for presenting a behavioral pattern is to be performed is made in response to a request from an application executed by the device 20, and then proceeds to step S114.

In step S114, the application cooperation processing unit 164 presents a behavioral pattern corresponding to the set location to the device 20. In this presentation processing, while the replay preparation processing (FIG. 9) is being executed on the user side, a behavioral pattern with a location tag assigned corresponding to the set location is presented to the application that has transmitted the request (S213 in FIG. 9).

FIG. 8 illustrates a flow of processing for linking a behavioral pattern with content and placing the content. In step S131, the control unit 151 classifies spatial sounds according to the world view of the work. In step S132, the control unit 151 assigns a tag to the characteristics of the spatial element content included in each spatial sound.

The classification of spatial sounds and the assign of tags to spatial element contents may be performed through an operation of the creator who produced the content or an operator on the service provider side, or may be performed (automatically) without an operation of the creator, by performing analysis processing on data of the spatial sounds or the spatial element contents.

In step S133, the content tag linking unit 163 assigns a tag (content tag) indicating the characteristics of a spatial element content to a behavioral pattern, thereby linking the adaptable behavioral pattern with the content tag. In other words, a behavioral pattern is assigned a content tag intended by the creator or service provider by matching with the tag indicating the characteristics of the spatial element content. The behavioral pattern used in this linking processing is the behavioral pattern set in the processing of step S111 in FIG. 7, and is also linked with the location tag (S112 in FIG. 7). This linking processing is also executed before the replay preparation processing on the user side (FIG. 9) is performed, and the behavioral pattern with the content tag assigned is prepared in advance as linking information.

In step S134, it is determined whether or not to perform processing for placing content. In step S134, the processing waits until a determination that the processing for placing content is to be performed is made in response to a request from an application executed by the device 20, and then proceeds to step S135.

In step S135, the application cooperation processing unit 164 places the spatial element content linked with the location according to the behavioral pattern and the spatial sound. In this placement processing, while the replay preparation processing (FIG. 9) on the user side is being executed, for the application that has transmitted the request, the spatial element content linked with the set location with a meaning assigned is selected from among the spatial element contents included in the spatial sound, and the selected spatial element content is placed.

As described above, in the processing on the service provider side, before the replay preparation processing on the user side (FIG. 9) is executed, a location tag and a content tag are assigned to a prepared behavioral pattern to link the behavioral pattern with the adaptable tag. While the replay preparation processing on the user side (FIG. 9) is executed, processing for presenting a behavioral pattern and processing for placing content are performed in cooperation with an application executed by the device 20.

### Replay Preparation Processing on User Side

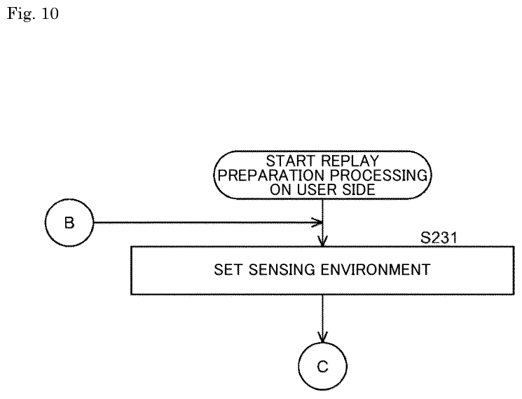

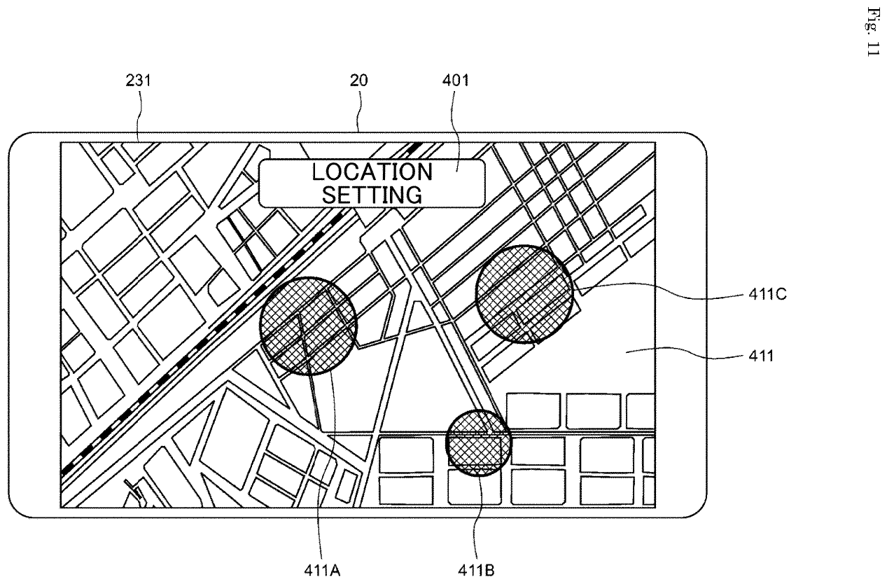

Next, a flow of the replay preparation processing on the user side executed by the control unit 251 of the device 20 will be described with reference to flowcharts of FIGS. 9 and 10. In the description with reference to FIG. 9, examples of user interfaces (UIs) in FIGS. 11 to 22 will be appropriately referred to.

In step S211, the control unit 251 controls the communication unit 209 to transmit a request to the server 10 via the network 30, thereby downloading an application for using the service. The downloaded application is recorded in the storage unit 208 and is started up. The user performs operations (e.g., tap operations) on a setting screen of the application displayed on the display unit 231 to register locations where the user wishes to experience sound.

In step S212, the location setting unit 271 sets locations as outdoors or indoors in response to user operations. The UIs of the application for setting locations are illustrated in FIGS. 11 to 13.

When setting an outdoor location, a setting screen 401 for “location setting” is displayed as illustrated in FIG. 11, allowing a specific location on a map 411 to be specified. The user can confirm, on the map 411, desired locations, such as the user's home, the nearest train station, a store where the user frequently stops at, a resting spot while jogging, or a bench where the user regularly sits on while walking, and specify them as areas 411A to 411C to be set.

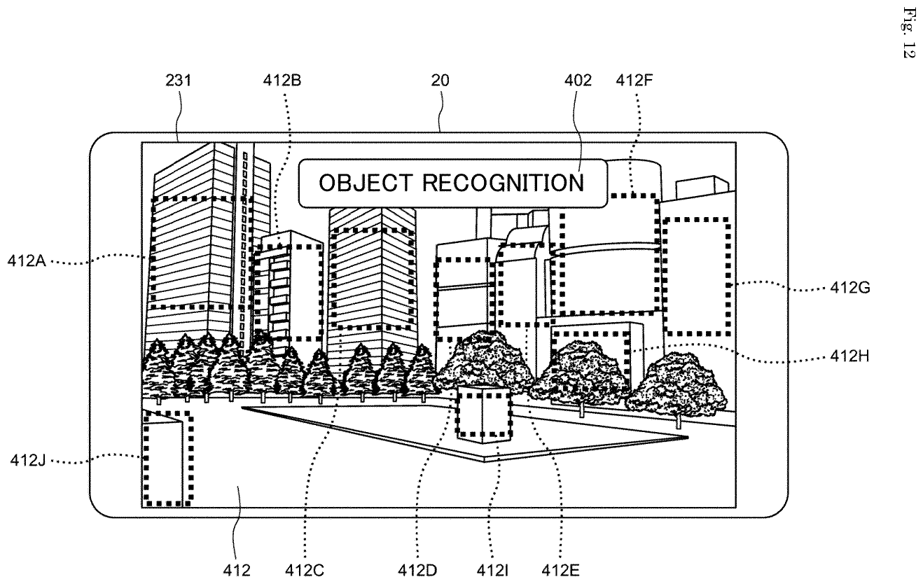

As illustrated in FIG. 12, an outdoor location may be set by recognizing as a recognition object an object (e.g., an object existing in real space such as a fountain or tree in a park, or a structure such as a building) included in a captured image captured by the camera unit 222 in cooperation with the application. The recognition object can be recognized by applying analysis processing to the captured image using known technologies. On a setting screen 402 for “object recognition”, recognition objects 412A to 412J enclosed in dotted lines on an outdoor captured image 412 are recognized so that their locations can be set.

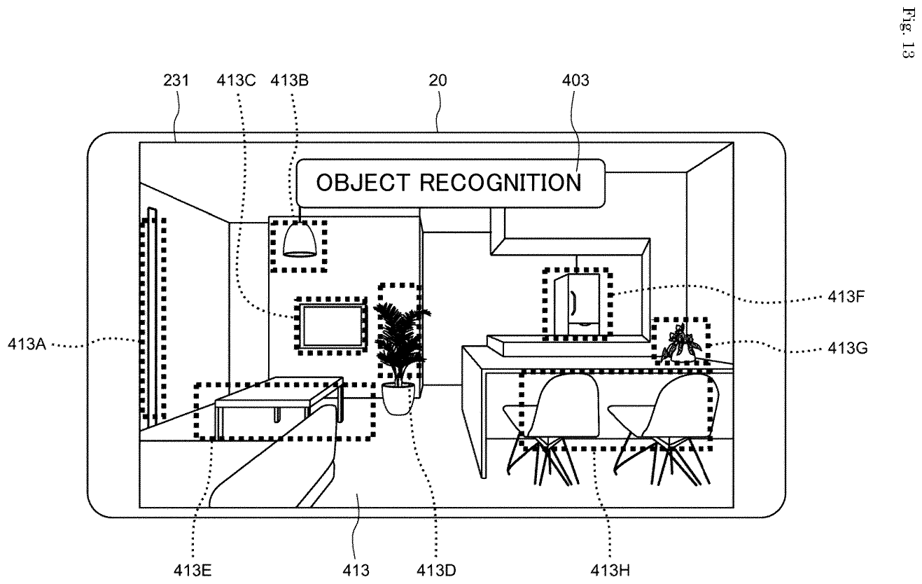

When setting an indoor location, as illustrated in FIG. 13, a setting screen 403 for “object recognition” is displayed, and recognition objects 413A to 413H (e.g., furniture, home appliance, room, etc.) enclosed by dotted lines on an indoor captured image 413 are recognized so that their locations can be set.

Specifically, analysis processing is applied to the captured image captured by the camera unit 222 in cooperation with the application, and a function of assisting in identifying a location using an object recognition identifier for identifying an object installed in a room is used, so that an object such as furniture, home appliance, or room (e.g., living room, dining table, bedroom, washroom, kitchen) can be recognized as a recognition object. For the function of assisting in identifying a location, a beacon, a token, a two-dimensional code (e.g., QR code (registered trademark)), an ultra wide band (UWB), light emitting diode (LED) lighting, or the like in cooperation with a device such as a wireless speaker installed in the room can be used.

In this way, for outdoors, an area set on the map or a recognition object is specified and for indoors, a recognition object is specified, thereby allowing an outdoor or indoor location to be set. In other words, with the specified area on the map or recognition object as a target, the set location is identified based on the relative positional relationship between the user and the target in real space.

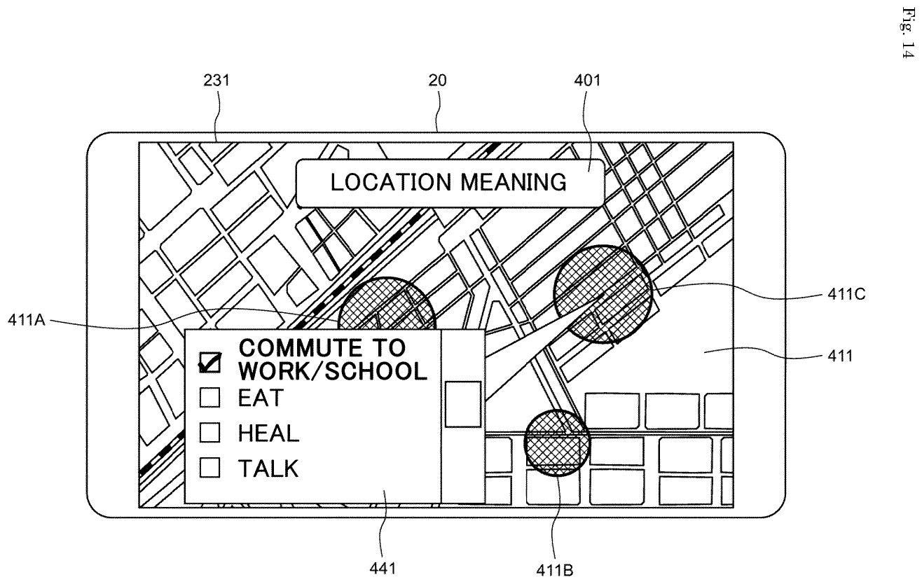

Returning to FIG. 9, in step S213, the behavioral pattern selection unit 272 presents behavioral patterns and receives a selection from the user. The behavioral patterns are assigned tags (S112 in FIG. 7) and presented by the server 10 (S114 in FIG. 7). In other words, the location tags of behavioral patterns are used to present the behavioral patterns adapted to the set locations set in step S212, so that the user can select a desired behavioral pattern from among the presented behavioral patterns. In step S214, the behavioral pattern setting unit 273 sets the selected behavioral pattern for the set location. In this way, the behavioral patterns selected by the user are set for the set locations, and a meaning is assigned to each set location. The UI of the application for assigning a meaning to a location is illustrated in FIGS. 14 to 16.

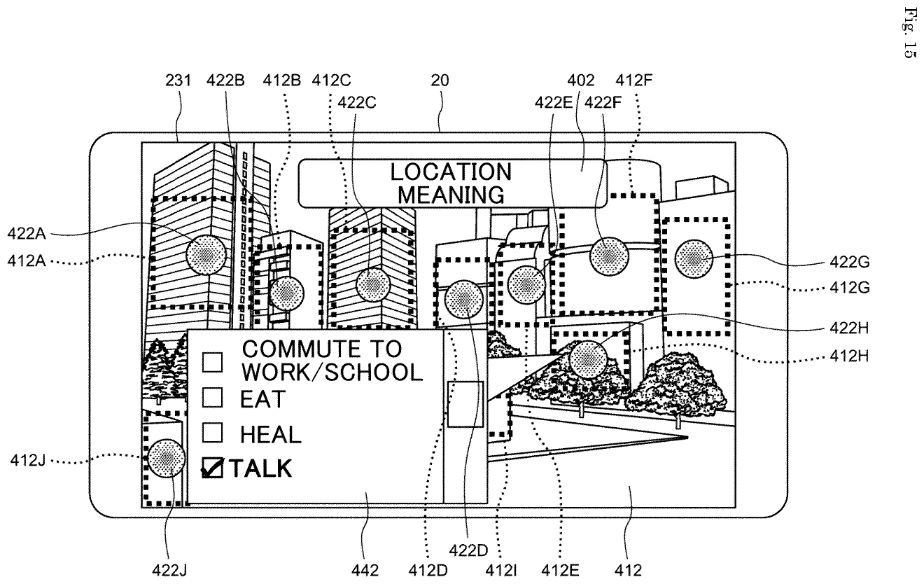

FIGS. 14 and 15 illustrate setting screens for “location meaning” when an outdoor location is set. In FIG. 14, a selection screen 441 is displayed for selecting a behavioral pattern such as “commute to work/school”, “eat”, “heal”, or “talk” for the area 411C set on the map 411. For example, when “commute to work/school” is selected on the selection screen 441 by a user operation, a behavioral pattern of “commute to work/school” is set for the location of the area 411C, thereby assigning a meaning to that location.

In FIG. 15, a selection screen 442 for selecting a behavioral pattern such as “commute to work/school” is displayed for location information 422H superimposed on the recognition object 412H included in the captured image 412. For example, when “talk” is selected on the selection screen 442 by a user operation, a behavioral pattern of “talk” is set for the location of the recognition object 412H, thereby assigning a meaning to that location.

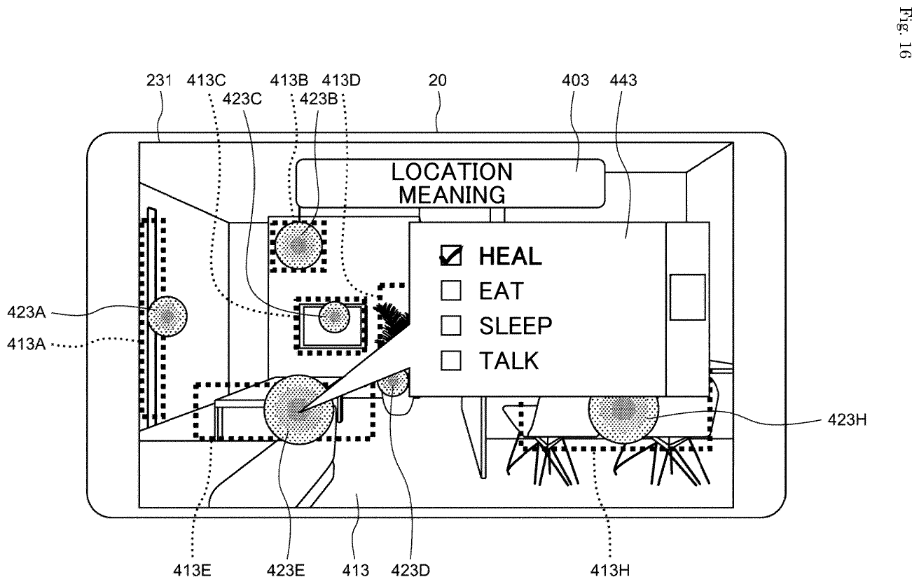

FIG. 16 illustrates a setting screen for “location meaning” when an indoor location is set. In FIG. 16, a selection screen 443 is displayed for selecting a behavioral pattern such as “heal”, “eat”, “sleep”, or “talk” for location information 423E superimposed on the recognition object 413E included in the captured image 413. For example, when “heal” is selected on the selection screen 443 by a user operation, a behavioral pattern of “heal” is set for the location of the recognition object 413E, thereby assigning a meaning to that location.

In this way, for both indoors and outdoors, the user selects and places a desired behavioral pattern for the presented location information on the setting screen for “location meaning”. The number and variety of behavioral patterns may be increased by allowing the user to input language, and based on the resulting input information such as characters and voice, performing analysis processing and learning processing on their content, and automatically generating behavioral patterns. Although the description will be omitted to avoid repetition, it is possible to set behavioral patterns for other set locations in the setting screen in a similar manner to assign a meaning to each location. Alternatively, other locations may be assigned the same meaning as a particular location.

Returning to FIG. 9, in step S215, the spatial sound selection unit 274 presents spatial sounds and receives a selection from the user. The spatial sounds are classified according to the world view of the work, and include spatial element contents with tags assigned (S131 and S132 in FIG. 8). By presenting spatial sounds recommended by the service provider, the user is allowed to select content that has a preferred world view.

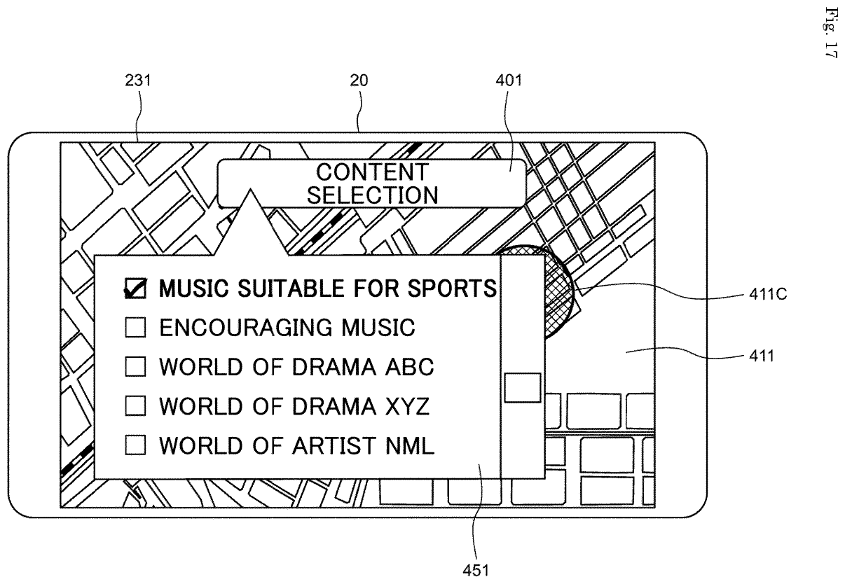

In addition to spatial sounds, channel information for streaming of a music distribution service used by the user, music content and its meta information recorded in the storage unit 208 of the device 20, and the like may be referred to, and their options may be presented in a selectable manner. UIs of the application for selecting content are illustrated in FIGS. 17 to 19.

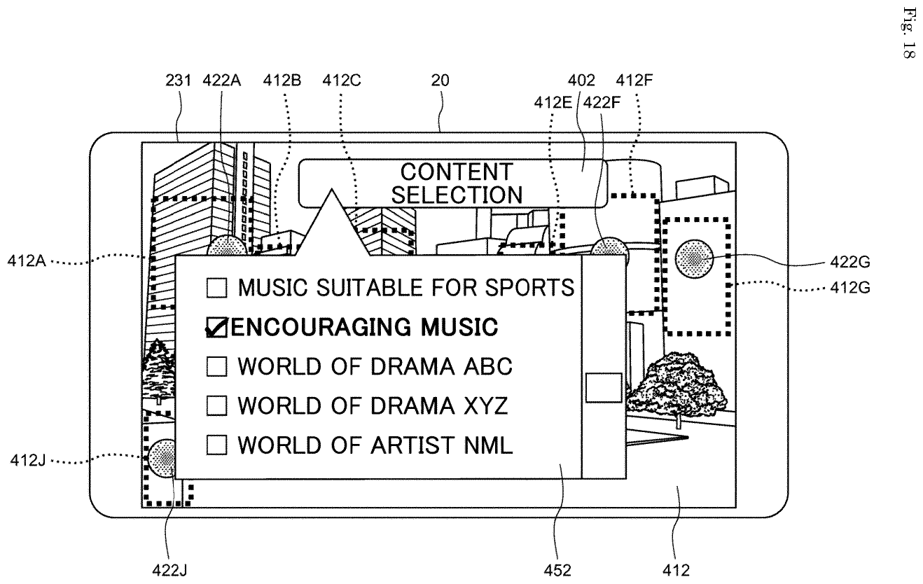

FIGS. 17 and 18 illustrate setting screens for “content selection” when an outdoor location is set. In FIG. 17, a selection screen 451 is displayed for selecting a spatial sound, such as “music suitable for sports”, “encouraging music”, “world of drama ABC”, “world of drama XYZ”, or “world of artist NML”, for the location of the area 411C for which a behavioral pattern of “commute to work/school” is set. For example, a spatial sound of “music suitable for sports” is selected on the selection screen 451 by a user operation.

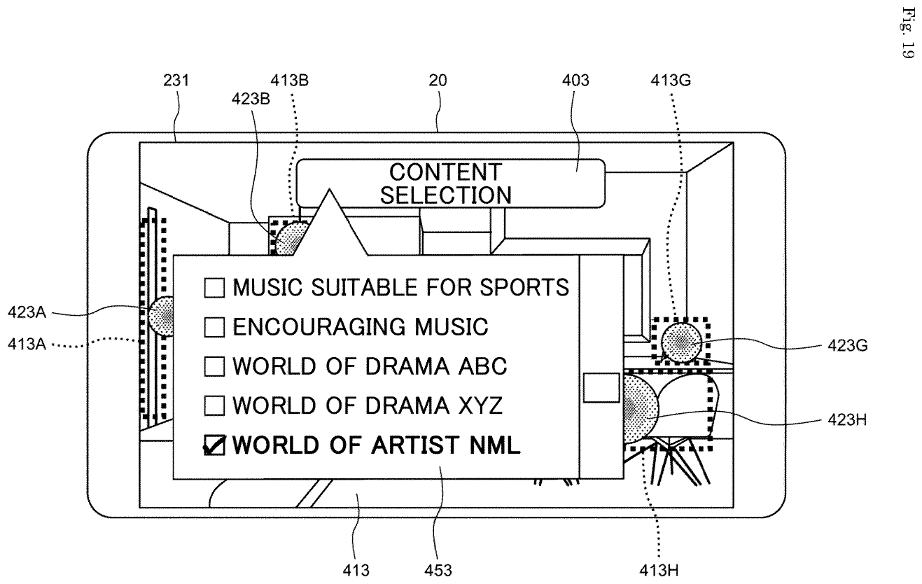

In FIG. 18, a selection screen 452 for selecting a spatial sound is presented for the location of the recognition object 412H for which a behavioral pattern of “talk” is set. For example, “encouraging music” is selected on the selection screen 452 by a user operation. In FIG. 19, a selection screen 453 for selecting a spatial sound is displayed for the location of the recognition object 413E for which a behavioral pattern of “heal” is set. For example, “world of artist NML” is selected on the selection screen 453 by a user operation.

Returning to FIG. 9, in step S216, the spatial element content setting unit 275 places the spatial element content linked with the set location according to the behavioral pattern and spatial sound. In step S217, the spatial element content setting unit 275 sets the placed spatial element content as content to be replayed when the replay conditions are satisfied.

The spatial element content to be placed here is the spatial element content included in the spatial sound, and is linked with the set location (the location with a meaning assigned) for which the behavioral pattern is set. In this way, the spatial element content to be placed in the set location is selected according to the association between the behavioral pattern and the characteristics of the location. In other words, since a tag is assigned to the behavioral pattern (S133 in FIG. 8), the spatial element content linked with the set location with a meaning assigned in step S214 is selected and placed from among the spatial element contents included in the spatial sound selected in step S215 based on the content tag of the behavioral pattern. In this way, the spatial element content is placed in each set location according to the association between the behavioral pattern and the characteristics of the spatial element content.

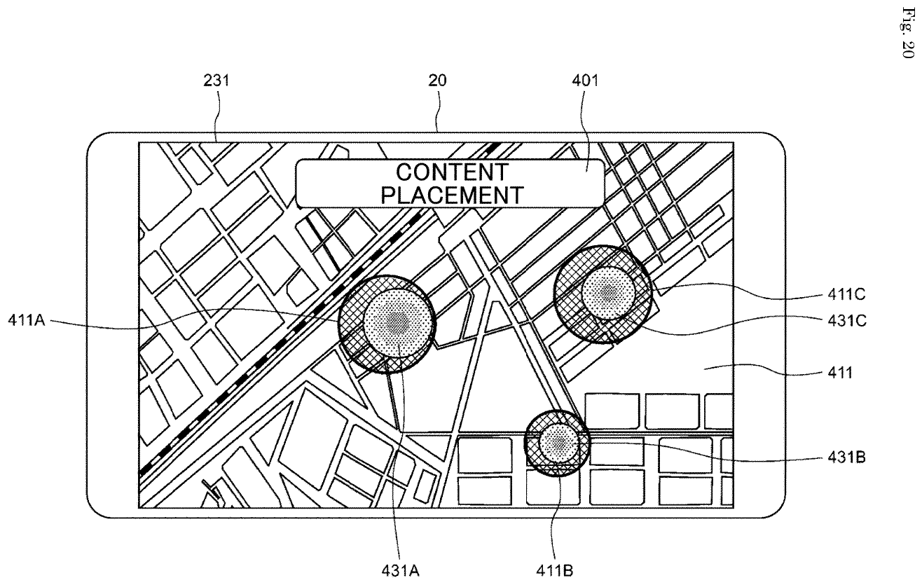

Then, after the above-described series of settings, the application (device-side application) executed by the device 20 on the user side communicates with the application (server-side application) executed by the server 10 on the service provider side. In this way, the applications cooperate with each other to comprehensively analyze the information and behavioral patterns selected by the user, and as a result, (the spatial element content included in) an appropriate spatial sound is automatically placed in each set location with a meaning assigned (S135 in FIG. 8, S216 in FIG. 9). Examples of UIs of the application for placing content are illustrated in FIGS. 20 to 22.

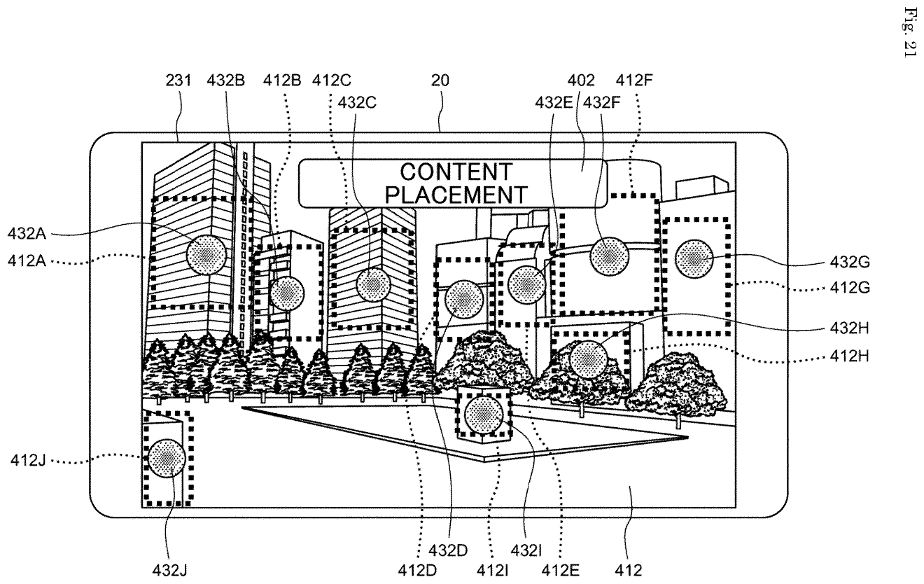

FIGS. 20 and 21 illustrate setting screens for “content placement” when an outdoor location is set. In FIG. 20, content information 431A to 431C indicating spatial element contents are placed in the locations of the areas 411A to 411C on the map 411, respectively. In FIG. 21, content information 432A to 432J indicating spatial element contents are placed in the locations of the recognition objects 412A to 412J on the captured image 412, respectively.

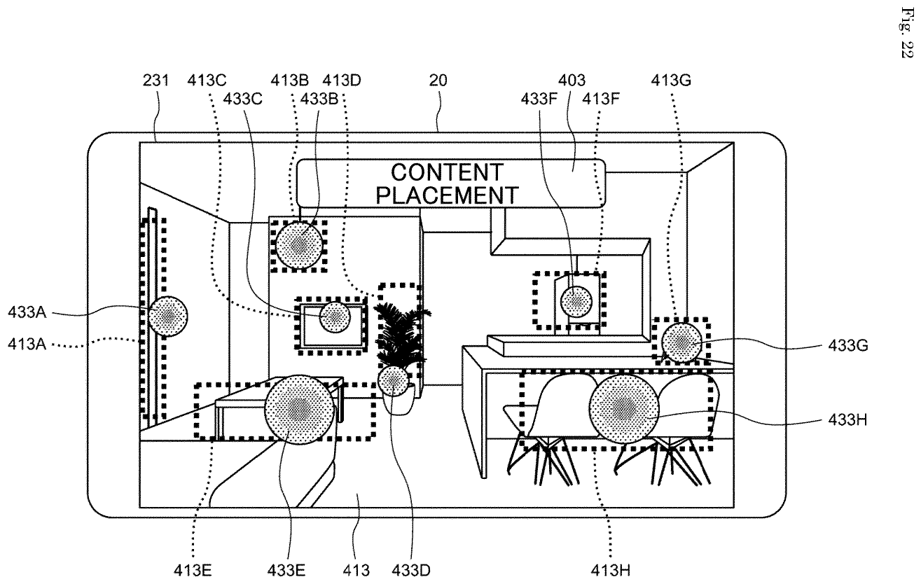

FIG. 22 illustrates a setting screen for “content placement” when an indoor location is set. In FIG. 22, content information 433A to 433H indicating spatial element contents are placed in the locations of the recognition objects 413A to 413H on the captured image 413, respectively.

Returning to FIG. 9, after the application is downloaded in step S211, the processing of step S231 in FIG. 10 is performed to set a sensing environment in parallel with the processing of steps S211 to S217. In the setting of the sensing environment, various settings are made for the camera unit 222, the sensor unit 223, the GPS unit 224, and others as sensing-related settings for measuring the relative positional relationship between the user and the target in real space.

When the processing of steps S212 to S217 in FIG. 9 and the processing of step S231 in FIG. 10 are completed, the processing proceeds to step S218. In step S218, the replay preparation unit 261 prepares for replaying spatial element content. In this replay preparation processing, processing such as generating replay conditions and preparing for replaying spatial element content when the replay conditions are satisfied are performed.

The replay conditions are determined, for example, based on the range of the set location or preset setting conditions. The range of the set location is a range in which spatial element content is replayed, and is determined by a predetermined shape (e.g., a circular or polygonal shape including the set location). The setting conditions are conditions determined by static or dynamic information such as human information, environmental information, and group information. The human information includes biometric information, context information, and the like. The environmental information includes information regarding date and time, day of the week, weather, and the like. The group information includes information regarding a single and a group (e.g., whether it is the user alone, or whether it includes other users in addition to the user), group characteristics, and the like. The information such as human information, environmental information, and group information may be prepared by the server 10 on the service provider side and provided to the device 20.

As described above, in the replay preparation processing on the user side, the user performs operations on a setting screen of the application to register the locations where the user wishes to experience sound, and thus content linked with each location is automatically placed and replay conditions for the content are automatically generated.

For example, when registering an outdoor location using map information, the setting screen 401 transitions in the order of “location setting” in FIG. 11, “location meaning” in FIG. 14, “content selection” in FIG. 17, and “content placement” in FIG. 20, and thus the content is automatically placed in a desired location according to an area on the map on the basis of the behavioral pattern, and the replay conditions for the content are automatically generated.

When registering an outdoor location using a recognition object, the setting screen 402 transitions in the order of “object recognition” in FIG. 12, “location meaning” in FIG. 15, “content selection” in FIG. 18, and “content placement” in FIG. 21, and thus the content is automatically placed in a desired location according to the recognition object on the basis of the behavioral pattern, and the replay conditions for the content are automatically generated. Similarly, when registering an indoor location using a recognition object, the setting screen 403 transitions in the order of “object recognition” in FIG. 13, “location meaning” in FIG. 16, “content selection” in FIG. 19, and “content placement” in FIG. 22, and thus the replay conditions for content are automatically generated.

In this way, the user performs operations on a setting screen of the application to place the prepared behavioral patterns in locations within the user's behavior range, making it possible to place a plurality of contents created by the creator in a plurality of locations based on the association with tags indicating the characteristics of the contents. Thus, from the viewpoint of the service provider and creator, it is possible to develop services with less effort (less labor and time) without having to carry out on-site investigation work regarding the current situation and characteristics and the like, and without having to carry out placement work regarding behavioral patterns and content and the like.

In the above-described series of processing, a case has been described in which a spatial sound is selected and spatial element content included in the spatial sound is placed in a location with a meaning assigned. However, spatial element content linked with a location may be placed without selecting a spatial sound. The point is that it is sufficient to place spatial element content linked with a location according to a behavioral pattern, and it is optional whether or not to define a spatial sound as a classification. In the case where, for example, channel information of streaming of a music distribution service is used instead of the spatial sound, music content included in the channel information selected by the user is placed as content linked with a location.

In the above-described series of processing, the user operations on the setting screen of the application include touch panel operations such as a tap operation, a drag-and-drop operation, a pinch-out operation, and a pinch-in operation. The operations are not limited to touch panel operations, and other operations may be performed, such as an operation of a physical button or an operation by the user's voice using voice input.

### Replay Processing on User Side

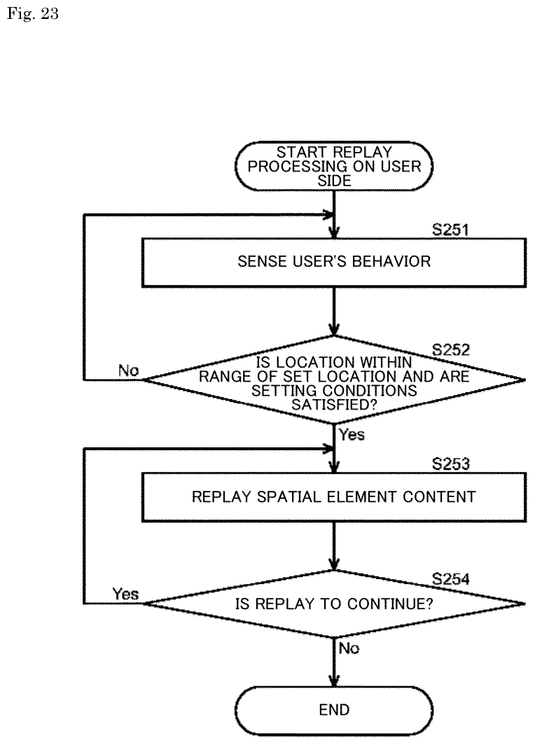

Next, a flow of the replay processing on the user side executed by the control unit 251 of the device 20 will be described with reference to a flowchart in FIG. 23. The replay processing is executed after the replay preparation processing described above (FIG. 9) is completed.

In step S251, the camera unit 222, the sensor unit 223, the GPS unit 224, and others sense the user's behavior in the set location under the control of the control unit 251. In step S252, the control unit 251 determines whether or not the location is within the range of the set location and whether or not setting conditions set in advance are satisfied, based on the sensing result and the replay conditions. The set location is identified based on the relative positional relationship between the user and the target in real space. In this determination processing, for example, the following determination is made.

Specifically, first, it is determined whether or not the position of the user who owns the device 20 is within the range of the set location defined by a predetermined shape, that is, within the range in which the spatial element content is replayed. For example, for outdoors, when an area is set on the map, information indicating the latitude and longitude of the target specified by the area can be acquired from the map information. Information indicating the latitude and longitude obtained by measurement using the GPS by the GPS unit 224 of the device 20 is converted into a relative position with respect to the target, and the relative position is compared with the position of the target, so that it is possible to determine whether the user is within the range of the set location. Here, in addition to or instead of map information provided by a map service, simultaneous localization and mapping (SLAM) or the like may be used. For indoors, image markers, beacons, and the like can be used. The point is that it is sufficient to determine whether the user is within the range of the set location, and any method for doing so is used.

Secondly, in the determination, it is determined whether or not setting conditions set in advance are satisfied based on information such as human information (biometric information, context information, etc.), environmental information (date and time, day of the week, weather, etc.), and group information (single or group, group characteristics, etc.). The information including the human information and others may be provided from the server 10 as appropriate.

If it is not determined in step S252 that the location is within the range of the set location and that the setting conditions are not satisfied, then the processing returns to step S251, and the sensing and the determination processing based on the sensing result are repeated. On the other hand, if it is determined in step S252 that the location is within the range of the set location and that the setting conditions are satisfied, the processing proceeds to step S253.

In step S253, the spatial element content replay unit 281 replays the spatial element content set in the replay preparation processing (FIG. 9). Thus, in the device 20, the sound of the spatial element content to be replayed is output from the sound output unit 232 including a speaker, headphones, or the like. In other words, when the user is wearing the device 20 with the application downloaded thereto and enters the range of the set location, replay of the spatial element content is started on the device 20 if the conditions set in advance are satisfied. This allows the user to experience the sound in the desired location.

In step S254, the control unit 251 determines whether or not to continue the replay of the spatial element content. If it is determined in step S254 that the replay is to be continued, the processing returns to step S253 to continue the replay of the spatial element content. On the other hand, if it is determined in step S254 that the replay is not to be continued, the replay of the spatial element content is stopped and the series of processing is ended. For example, it is determined that the replay is not to continue when the user moves out of the range of the set location, when the setting conditions are no longer satisfied, when the user explicitly instructs the replay to end, or when the replay of the spatial element content is completed.

As described above, in the replay processing on the user side, sensing is performed by the sensor unit 223 and others, and if it is determined that the replay conditions generated in the replay preparation processing are satisfied, the content set in the replay preparation processing is replayed. Although a case has been described in which the range of the set location and the setting conditions set in advance are used as the replay conditions, the setting conditions do not necessarily have to be used.

### Device and Other Configuration

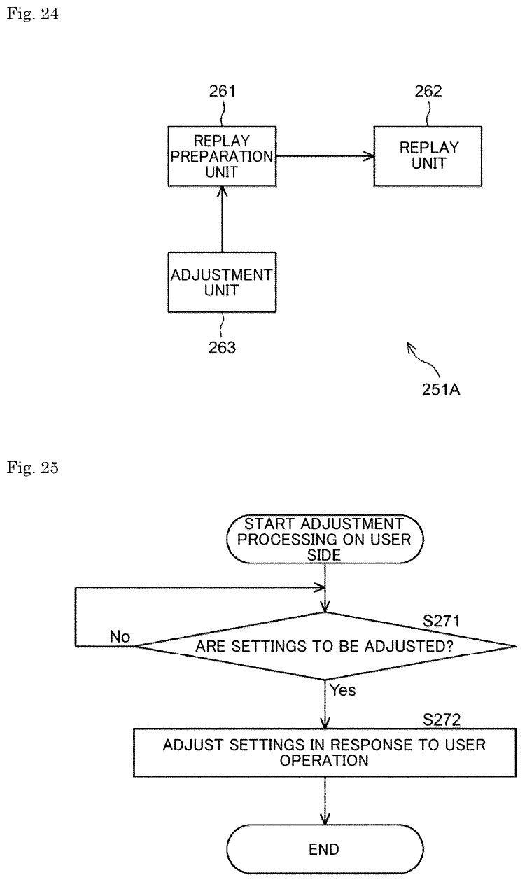

FIG. 24 is a diagram illustrating another example of the functional configuration of the control unit 251 in the device 20 of FIG. 4.

Compared to the control unit 251 in FIG. 5, a control unit 251A in FIG. 24 further includes an adjustment unit 263 in addition to the replay preparation unit 261 and the replay unit 262.

The adjustment unit 263 performs adjustment processing to adjust the settings set in the replay preparation processing by the replay preparation unit 261 in response to a user operation. The adjustment processing includes, for example, adjusting the set location set by the location setting unit 271, the selection of the spatial sound selected by the spatial sound selection unit 274, and the placement of the spatial element content set by the spatial element content setting unit 275.

### Adjustment Processing on User Side

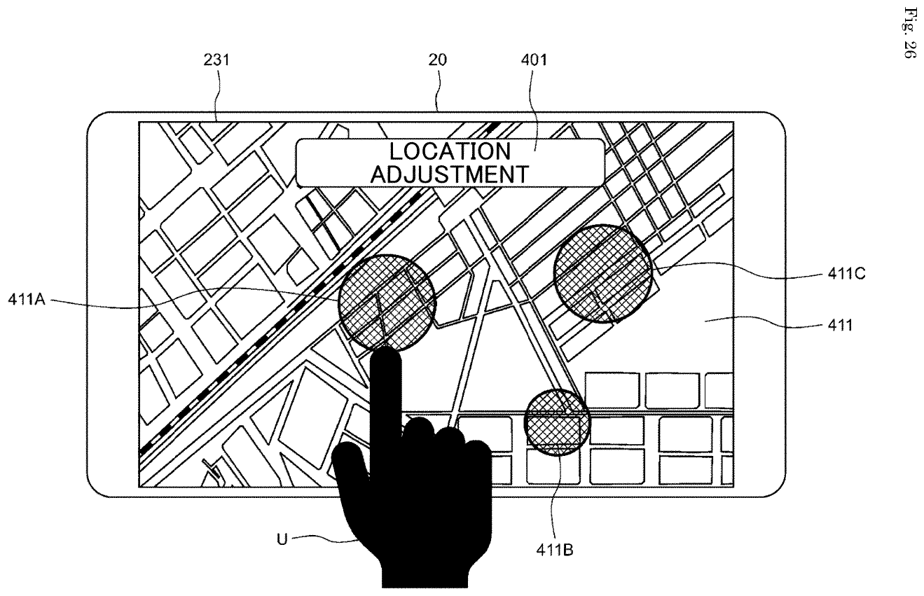

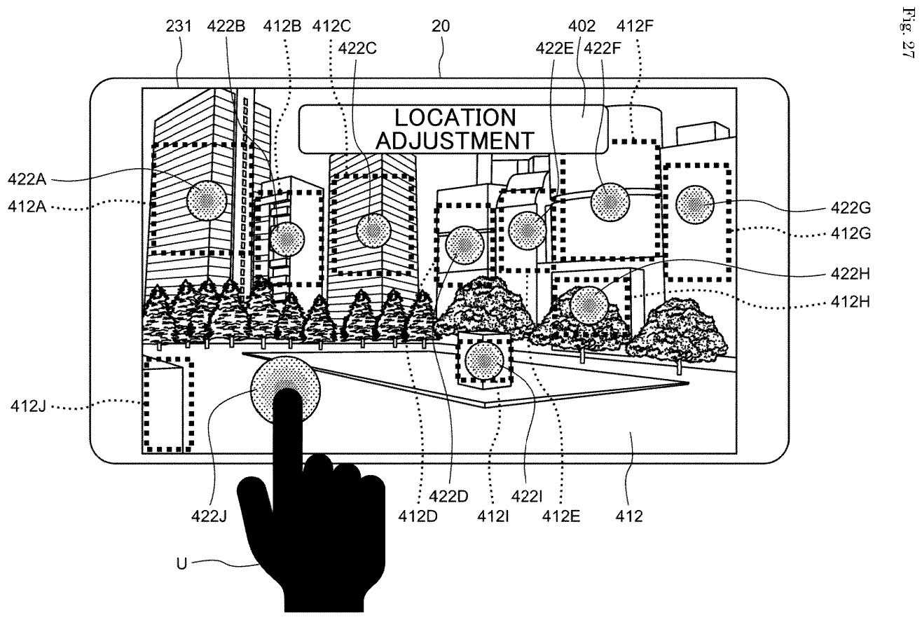

Next, a flow of the adjustment processing on the user side executed by the control unit 251A of the device 20 will be described with reference to a flowchart of FIG. 25. For the description of FIG. 25, examples of UIs in FIGS. 26 to 28 will be referred to as appropriate.

In step S271, the control unit 251A determines whether or not to adjust the settings. In step S271, the processing waits until a determination that the settings are to be adjusted in response to an instruction from the user, and then the processing proceeds to step S272.

In step S272, the adjustment unit 263 adjusts the settings such as the set location, spatial sound, and spatial element content in response to a user operation. Application UIs for adjusting the settings are illustrated in FIGS. 26 to 28.

When adjusting the set locations for outdoors, a setting screen 401 for “location adjustment” is displayed as illustrated in FIG. 26, and the location adjustment is performed by moving the areas 411A to 411C set on the map 411 to desired locations. For example, the user U is allowed to move and adjust the area 411A to a desired location on the map 411 by dragging and dropping the area 411A. Thus, the location of the spatial element content within the area 411A is adjusted.

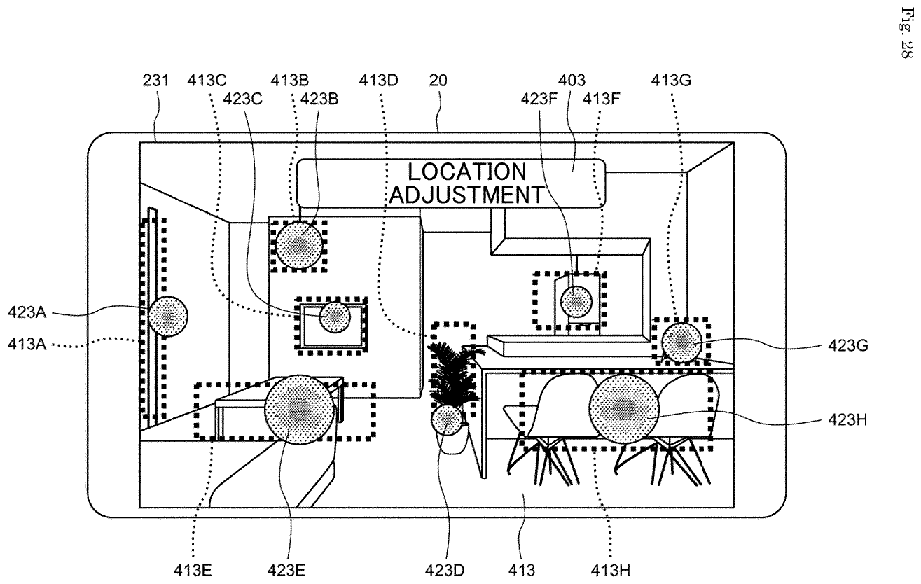

In addition, when adjusting the locations of the recognition objects for outdoors, a setting screen 402 for “location adjustment” is displayed as illustrated in FIG. 27, and the location adjustment is performed by moving the recognition objects 412A to 412J included in the captured image 412 to desired locations. For example, to adjust the location of the recognition object 412J, the user U can drag and drop location information 422J superimposed on the recognition object 412J to move it to the desired location on the captured image 412, thereby adjusting that location. Thus, the location of the spatial element content to be placed corresponding to the location information 422J is adjusted. Instead of the location information 422J, content information 432J placed corresponding to the location may be operated.

Although not illustrated, adjusting the locations of the indoor recognition objects is performed in the same way as adjusting the locations of the outdoor recognition objects by moving location information 423 (or content information 433) superimposed on the recognition objects 413A to 413H included in the captured image 413 to desired locations.

The adjustment of the location of the spatial element content linked with the location of a recognition object is performed, for example, as follows in the case of a physically movable object. Specifically, after the object is moved in real space, the recognition object is recognized again in the scene including the moved object, by using a camera function as one of the functions of the setting screen for “location adjustment”, and the relationship between the change and the spatial sound is automatically updated. This allows for location adjustment and spatial editing within the space surrounding the user.

Specifically, as illustrated in FIG. 28, when a potted plant placed at the back of a room is moved to the vicinity of a table in the front in the real space, the movement of the potted plant is recognized by image recognition, and the position of location information 423D (or content information 433D) is changed in accordance with the change in the position of a recognized recognition object 413D. For convenience of explanation herein, the movement of an object (e.g., a potted plant) within the same room is exemplified. However, the object may be one that has been moved from another place (e.g., another room such as a bedroom).

The adjustment processing on the user side can be performed by the application executed by the device 20 (device-side application) performing processing in cooperation with the application executed by the server 10 (server-side application), similar to the replay preparation processing described above.

As described above, the adjustment processing on the user side allows the user to freely change settings such as the location and spatial sound set by the user, or the location of spatial element content placed by the service provider using the system. For example, the user can adjust a spatial sound linked with a location based on a behavioral pattern, depending on the experience the user gets from using it. More specifically, since it is possible to adjust the selection of a spatial sound, placement of spatial element content, replay conditions, and the like, the user can create a sound space that is optimized for the user's own usage and feeling.

### Device and Other Configuration

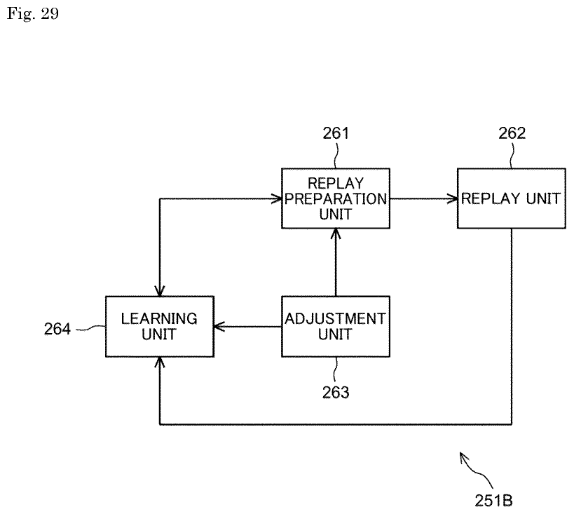

FIG. 29 is a diagram illustrating still another example of the functional configuration of the control unit 251 in the device 20 of FIG. 4.

Compared to the control unit 251A in FIG. 24, a control unit 251B in FIG. 29 further includes a learning unit 264 in addition to the replay preparation unit 261, the replay unit 262, and the adjustment unit 263.

The learning unit 264 performs machine learning using learning data, generates a learned model, and supplies the learned model to the replay preparation unit 261. As the learning data, data input from the replay preparation unit 261, the replay unit 262, and the adjustment unit 263 can be used. The adjustment unit 263 performs adjustment processing to adjust the settings set in the replay preparation processing by the replay preparation unit 261 in response to a user operation, and data regarding the settings and adjustments can be used as learning data. The learning data may also include data regarding the replay content replayed in the replay processing by the replay unit 262. The learning data may be data input from an external source.

By using such learning data, the learning unit 264 learns, for example, the state of the user's selection and change of spatial sound, the state of the user's setting and change of spatial element content, the state of the replay of spatial element content, and the like. For the learned model, a deep neural network (DNN) can be used that has been learned using data on the settings, adjustments, and replay contents as learning data as input and data on corrected settings as output. As such a DNN-based algorithm, known technologies can be used. For example, for learning, by using data on the adjustments is used as teacher data, the settings that take into account the user's adjustments are output as corrected settings.

The learned model is supplied from the learning unit 264 to the replay preparation unit 261. When performing the replay preparation processing, the replay preparation unit 261 can input data on settings according to a user operation to the learned model, and obtain data on corrected settings as the output. In the replay preparation processing, at least a portion of the processing can be performed using the learned model. For example, in the replay preparation processing, the learned model can be used to correct the settings of the combination of the location and spatial element content based on a behavioral pattern, thereby improving the accuracy of the placement location of the spatial element content.

As described above, when the learning unit 264 is provided and the user changes the settings according to the experience the user gets from using the system, machine learning is performed using data related to the settings, adjustments, and replay contents as learning data, so that the replay preparation processing can use the learned model obtained by machine learning to perform processing. Although FIG. 29 illustrates a configuration in which the learning unit 264 is provided in the control unit 251B on the device 20 side, the learning unit 264 may be provided in the control unit 151 on the server 10 side. In the case where the control unit 151 includes the learning unit 264, data regarding the settings, adjustments, and replay contents is transmitted from the device 20 to the server 10, and the learning unit 264 performs machine learning using that data to generate a learned model. The learned model is transmitted from the server 10 to the device 20 and recorded in the storage unit 208.

The system configuration proposed in the present disclosure and the processing executed by each device have been described above. In the technology proposed in the present disclosure, by linking a location with content based on a prepared behavioral pattern, the content associated with the location can be replayed in accordance with the user's behavior.

Whether indoors or outdoors, a user being able to enjoy music that matches the user's diverse behaviors and actions in such various locations is an important experience in daily life. However, in most cases, users typically select and replay desired music content that matches their own mental image at a given location or time by selecting music from a streaming channel of a music distribution service or by accessing music content files stored on their device.

In recent years, some devices such as smartphones and portable music players have functions to grasp location information and biometric information, and functions are being provided that utilize such information to recommend music based on the selection and listening records of the music contents that have been replayed by the user.

On the other hand, mainly in outdoor cases, there has been an increase in cases in theme parks, amusement parks, and even in specific city areas where music, sound effects, narration, and the like are replayed in specific locations with the aim of enhancing the various experiential value provided by business owners, promoters, and the like. In this type of case, a system is used in which a business owner or promoter places music content and the like on a map in advance, and the music content and the like are replayed by utilizing the GPS function of a device such as a smartphone owned by the user to detect when the user enters or leaves the placement location.

The case of special, out-of-the-ordinary experiences such as at theme parks, amusement parks, and even in specific city areas described above is a model in which business owners, promoters, and the like promise to provide the experience in an area agreed upon in advance with the user. Therefore, with such an area being limited and the characteristics of each location within that area being understood, music content can be placed and replay conditions can be set.

However, when it is difficult to identify the user's destination or when it is difficult to identify the user's daily living area, it is not easy to identify the location where the user wishes to listen to music, and it is not easy to select the desired music content that matches the user's own mental image and set the timing of presentation. Naturally, it is not realistic for service providers and creators, such as business owners and promoters, to research the trends and preferences of individual users, identify their locations, and place music content there, considering the burden on them.

In the method proposed in the present disclosure, the user performs operations on a setting screen of an application to link a location and content based on a prepared behavioral pattern. Therefore, service providers and creators can develop services with less effort (less labor and time) without having to investigate the trends and preferences of individual users or identify locations to place music content. It is also possible to provide content that the user expects to be replayed appropriately in each location, thereby providing a better user experience.

### Modification Example

In the above description, the functional configuration of the control unit 251 of the device 20 is illustrated in FIG. 5. However, some of the functions of the replay preparation unit 261 and replay unit 262 in the control unit 251 may be provided in the control unit 151 of the server 10. Thus, the above-described series of processing can be performed by cooperation between (the control unit 151 of) the server 10 on the service provider side and (the control unit 251 of) the device 20 on the user side. In other words, the embodiments of the present disclosure may be configured through cloud computing in which a plurality of devices share and cooperatively process one function over a network.

In the above description, “relative positional relationship between the user and the target in real space” has been described. However, since the position of the user is equivalent to the position of the device 20 owned by the user, the relative positional relationship can also be considered as the positional relationship between the device 20 owned by the user and the target (a target specified by an area on a map or a recognition object).

In the above description, spatial sound that provides a space based on the world view of a work through sound has been exemplified as spatial content. However, other information such as video and images may also be presented. For example, spatial content can provide a space based on the theme of “healing”, “power”, “memories”, and the like through sound such as stereophonic sound, video, images, and the like. For example, spatial content for “healing” includes spatial element content (music content) such as “bird”, “forest”, and “creek”. A spatial element content of “bird” provides the user with a “healing” space with the soothing sounds of birds. A spatial element content of “forest” provides the user with a “healing” space through sounds that allow the user to feel like being in a forest, such as the sound of wind rustling leaves. A spatial element content of “creek” provides the user with a “healing” space through the sounds of water, such as a gently flowing stream.

In the setting screen 402 for “object recognition” in FIG. 12 or the setting screen 403 for “object recognition” in FIG. 13, a recognition object included in an image captured by the camera unit 222 in cooperation with an application is automatically recognized and its location is set as described above. However, the user may manually specify an object included in the captured image (an object that exists in real space, such as a fountain in a park), thereby recognizing the specified object as a recognition object and setting its location. As used herein, the term “automatic” means that a device such as the server 10 or the device 20 performs processing without direct operation by a user, a service provider, a creator, or the like, and the term “manual” means that such a device performs processing through direct operation by a user or the like.

### Computer Configuration

The processing steps of the above-described flowcharts can be executed by hardware or software. In the case where the series of processing is executed by software, a program that configures the software is installed on a computer of each device.

The program to be executed by the computer can be provided in such a manner as to be recorded on, for example, a removable recording medium serving as a packaged medium. The program can be supplied via a wired or wireless transmission medium such as a local area network, the Internet, or digital satellite broadcasting.

In the computer, by loading the removable recording medium into a drive, the program can be installed in a storage unit via an input/output interface. The program can be received by a communication unit via the wired or wireless transmission medium and installed in the storage unit. In addition, the program can be installed in advance in the ROM or the storage unit.

The processing executed by the computer in accordance with the program described herein may not necessarily be executed chronologically in the order described as the flowcharts. In other words, the processing executed by the computer in accordance with the program also includes processing that is executed in parallel or individually (e.g., parallel processing or processing by objects). The program may be processed by a single computer (processor) or processed in a distributed manner by a plurality of computers. Further, the program may be transmitted to a remote computer and executed there.

Each step described in the above flowcharts can be performed by one device or executed in a shared manner by a plurality of devices. Furthermore, in a case in which one step includes a plurality of types of processing, the plurality of types of processing included in the one step can be performed by one device or performed in a shared manner by a plurality of devices.

Embodiments of the present disclosure are not limited to the above-described embodiments, and various modifications can be made without departing from the essential spirit of the present disclosure. The effects described herein are merely illustrative and not limiting, and other effects may be obtained.

The present disclosure can also be configured as follows.
(1)

An information processing device in which behavioral patterns indicating behaviors of users are set in advance, the information processing device including a control unit that
sets, for a specific location identified by a relative positional relationship between a specific user and a target in real space, the behavioral pattern according to the specific user, and
sets a specific content associated with the specific location from among a plurality of contents according to the set behavioral pattern.
(2)

The information processing device according to (1), wherein
the behavioral pattern is assigned meta information adapted to meta information indicating characteristics of a location and meta information indicating characteristics of content, and
the specific location is associated with the specific content through the meta information assigned to the behavioral pattern.
(3)

The information processing device according to (2), wherein the control unit places the specific content in the specific location according to an association between the behavioral pattern and the characteristics of the content.
(4)

The information processing device according to (2), wherein the control unit selects the specific content to be placed in the specific location according to an association between the behavioral pattern and the characteristics of the location.
(5)

The information processing device according to (2), wherein the behavioral pattern is assigned meta information intended by a creator who produces the content or a provider who provides the content by matching with the meta information indicating the characteristics of the content.
(6)

The information processing device according to (1), wherein the control unit adjusts at least one of settings of the specific location and the specific content in response to an operation of the specific user.
(7)

The information processing device according to (6), wherein the control unit performs machine learning using data on the settings of the specific location and the specific content and data on adjustments made in response to an operation of the user as learning data, and generates a learned model.
(8)

The information processing device according to (7), wherein
the learned model is a DNN learned with the data on the settings and the adjustments as input and data on corrected settings as output, and
the control unit corrects at least one of the settings of the specific location and the specific content by using the learned model.
(9)

The information processing device according to (1), wherein the control unit replays the specific content when a replay condition for the specific location is satisfied.
(10)

The information processing device according to (9), wherein the control unit replays the specific content when the user is within a range corresponding to the specific location and a setting condition set in advance is satisfied.
(11)

The information processing device according to any one of (1) to (10), wherein
the plurality of contents include spatial element contents classified by spatial contents, and
the control unit selects the spatial content in response to an operation of the user, and places the spatial element content included in the selected spatial content as the specific content associated with the specific location.
(12)

The information processing device according to (11), wherein
the spatial content is a spatial sound that provides a space based on world view of a work through sound, and
the spatial element content is music content.
(13)

The information processing device according to any one of (1) to (10), wherein the target is specified by an area set on a map or a recognition object that is a recognized object existing in real space.
(14)

An information processing method including: by an information processing device
in which behavioral patterns indicating behaviors of users are set in advance,
setting, for a specific location identified by a relative positional relationship between a specific user and a target in real space, the behavioral pattern according to the specific user; and
setting a specific content associated with the specific location from among a plurality of contents according to the set behavioral pattern.
(15)

A program causing a computer
in which behavioral patterns indicating behaviors of users are set in advance, to function as a control unit that
sets, for a specific location identified by a relative positional relationship between a specific user and a target in real space, the behavioral pattern according to the specific user, and
sets a specific content associated with the specific location from among a plurality of contents according to the set behavioral pattern.

### REFERENCE SIGNS LIST

1 System
10 Server
20, 20-1 to 20-N Device
30 Network
101 CPU
151 Control unit
161 Behavioral pattern setting unit
162 Location tag linking unit
163 Content tag linking unit
164 Application linking processing unit
201 CPU
251, 251A, 251B Control unit
261 Replay preparation unit
262 Replay unit
263 Adjustment unit
264 Learning unit
271 Location setting unit
272 Behavioral pattern selection unit
273 Behavioral pattern setting unit
274 Spatial sound selection unit
275 Spatial element content setting unit
281 Spatial element content replay unit

1. An information processing device in which behavioral patterns indicating behaviors of users are set in advance, the information processing device comprising a control unit that
sets, for a specific location identified by a relative positional relationship between a specific user and a target in real space, the behavioral pattern according to the specific user, and
sets a specific content associated with the specific location from among a plurality of contents according to the set behavioral pattern.

2. The information processing device according to claim 1, wherein
the behavioral pattern is assigned meta information adapted to meta information indicating characteristics of a location and meta information indicating characteristics of content, and
the specific location is associated with the specific content through the meta information assigned to the behavioral pattern.

3. The information processing device according to claim 2, wherein the control unit places the specific content in the specific location according to an association between the behavioral pattern and the characteristics of the content.

4. The information processing device according to claim 2, wherein the control unit selects the specific content to be placed in the specific location according to an association between the behavioral pattern and the characteristics of the location.

5. The information processing device according to claim 2, wherein the behavioral pattern is assigned meta information intended by a creator who produces the content or a provider who provides the content by matching with the meta information indicating the characteristics of the content.

6. The information processing device according to claim 1, wherein the control unit adjusts at least one of settings of the specific location and the specific content in response to an operation of the specific user.

7. The information processing device according to claim 6, wherein the control unit performs machine learning using data on the settings of the specific location and the specific content and data on adjustments made in response to an operation of the user as learning data, and generates a learned model.

8. The information processing device according to claim 7, wherein
the learned model is a DNN learned with the data on the settings and the adjustments as input and data on corrected settings as output, and
the control unit corrects at least one of the settings of the specific location and the specific content by using the learned model.

9. The information processing device according to claim 1, wherein the control unit replays the specific content when a replay condition for the specific location is satisfied.

10. The information processing device according to claim 9, wherein the control unit replays the specific content when the user is within a range corresponding to the specific location and a setting condition set in advance is satisfied.

11. The information processing device according to claim 1, wherein
the plurality of contents include spatial element contents classified by spatial contents, and
the control unit selects the spatial content in response to an operation of the user, and places the spatial element content included in the selected spatial content as the specific content associated with the specific location.

12. The information processing device according to claim 11, wherein
the spatial content is a spatial sound that provides a space based on world view of a work through sound, and
the spatial element content is music content.

13. The information processing device according to claim 1, wherein the target is specified by an area set on a map or a recognition object that is a recognized object existing in real space.

14. An information processing method comprising: by an information processing device
in which behavioral patterns indicating behaviors of users are set in advance,
setting, for a specific location identified by a relative positional relationship between a specific user and a target in real space, the behavioral pattern according to the specific user; and
setting a specific content associated with the specific location from among a plurality of contents according to the set behavioral pattern.

15. A program causing a computer
in which behavioral patterns indicating behaviors of users are set in advance, to function as a control unit that
sets, for a specific location identified by a relative positional relationship between a specific user and a target in real space, the behavioral pattern according to the specific user, and
sets a specific content associated with the specific location from among a plurality of contents according to the set behavioral pattern.
